(19) United States
(12) Patent Application Publication
(10) Pub. No.: US 2002/0015465 A1
(43) Pub. Date: Feb. 7, 2002

(54) ASSEMBLY FRAME FOR NUCLEAR FUEL WITH GUIDE TUBES AND METHOD FOR MANUFACTURING SAME

(76) Inventor: ALAIN BROSSET, FONTAINES SAINT-MARTIN (FR)

Correspondence Address: CONNOLLY BOVE LODGE & HUTZ, 1990 M STREET NW, SUITE 800, WASHINGTON, DC, 20036-3425, US

(21) Appl. No.: 09/269,309

(22) PCT Filed: Sep. 29, 1997
(86) PCT No.: PCT/FR97/01708

(30) Foreign Application Priority Data
Sep. 30, 1996 (FR) 96 11870

(51) Int. Cl. G21C 3/00

(52) U.S. Cl. 376/409

(57) ABSTRACT

A nuclear fuel assembly skeleton having a top nozzle and a bottom nozzle (10) interconnected by guide tubes (16) designed to receive control cluster rods and each containing, at its bottom end, a tubular cartridge (20), each of said tubes being provided with a bottom plug (22) that bears against the bottom nozzle (10) and that is pierced by a hole for passing a fixing screw (26). The cartridge (20) includes a bottom plug (28) bearing against the guidetube plug (22) and in that the facing faces of the two plugs (22, 28) present axial projections that co-operate with one another to lock the two plugs against relative rotation once said screw (26) has been screwed into a tapped hole (32) in the cartridge plug (28).

The present invention relates to nuclear fuel assembly skeletons having a top nozzle and a bottom nozzle interconnected by guide tubes for receiving control cluster rods and which generally have grids fixed thereto for supporting and/or holding fuel rods laterally.

In general, the bottom portion of each guide tube is designed to hydraulically brake the descent of a rod as it approaches its bottom position. For that purpose, the bottom portion of the guide tube is shaped to constrict the flow of the cooling liquid expelled by the rod. Several solutions are in existence. One of them consists in reducing the inside diameter of the guide tube in a portion near the bottom thereof. The invention relates more particularly to another type of solution in which the bottom portion of a guide tube contains a tubular cartridge having a bottom plug, bearing against a bottom end plug of the guide tube which in turn bears against the bottom nozzle. The cartridge reduces the section through which coolant can escape around the rod of the cluster. An additional constricted passage is generally provided on the axis of a screw for fixing a plug to the bottom nozzle.

The present invention seeks in particular to provide a skeleton in which plug-and-guidetube assemblies are fixed securely to the nozzle.

To do this, the invention provides in particular a skeleton in which the facing faces of each guidetube plug and each corresponding cartridge plug have axial projections that co-operate with each other to prevent relative rotation between the two plugs.

This eliminates any risk of relative rotation between the plugs. The clamping torque on the screw in each cartridge plug is transferred to the guidetube plug and thus to the nozzle. Relative rotation is prevented by means of a link that can be referred to as positive or as “shape-engagement”, in contrast to a link by means of friction.

The axial projections can have a very wide variety of shapes. They may constitute a jaw clutch. One of the plugs may be provided with a diametral tenon penetrating into a mortise in the other plug. The projections may be constituted by complementary sets of teeth. Each projection may extend angularly over 180° and be in the form of a half-moon.

The invention is applicable regardless of the length of the cartridge. It can be used equally well in assemblies where the top end of the cartridge lies between the bottom grid and the grid immediately above it (as applies to a 900 MWe reactor) and in assemblies where the cartridge terminates above the bottom two grids (as in 1300 MWe reactors).

The present invention also proposes a method of assembling an assembly skeleton, in which:

blocks are built up, each constituted by a cartridge and a bottom terminal plug having a tapped hole, the cartridge and the plug being fixed together (e.g. by crimping in a circumferential groove of the plug);

a skeleton subassembly is built up comprising guide tubes, each provided with a bottom plug pierced by a smooth axial hole, the tubes being assembled together by grids welded to the tubes;

the blocks are inserted as snug fits in respective guide tubes and they are oriented so as to cause the facing projections of the cartridge and guidetube plugs to engage mutually; and

a bottom nozzle of the assembly is fixed to the guide tubes by screws each having a head bearing against the nozzle and a shank passing through the bottom plug of the guide tube and screwed into the tapped hole of the cartridge plug.

This method makes it possible to avoid fixing the cartridge to the guide tube energetically by welding, which would be difficult to perform given that it is almost impossible to use spot welding to fix together three concentric elements, i.e. a sleeve of the grid to be secured to a guide tube, a the guide tube, and the cartridge.

The above characteristics, and others, appear more clearly on reading the following description of particular embodiments of the invention, given as non-limiting examples. The description refers to the accompanying drawings, in which:

FIG. 1 is a large scale diagram showing the relative disposition, in an embodiment of the invention, of the nozzles, of two bottom grids, and of a guide tube provided with a cartridge;

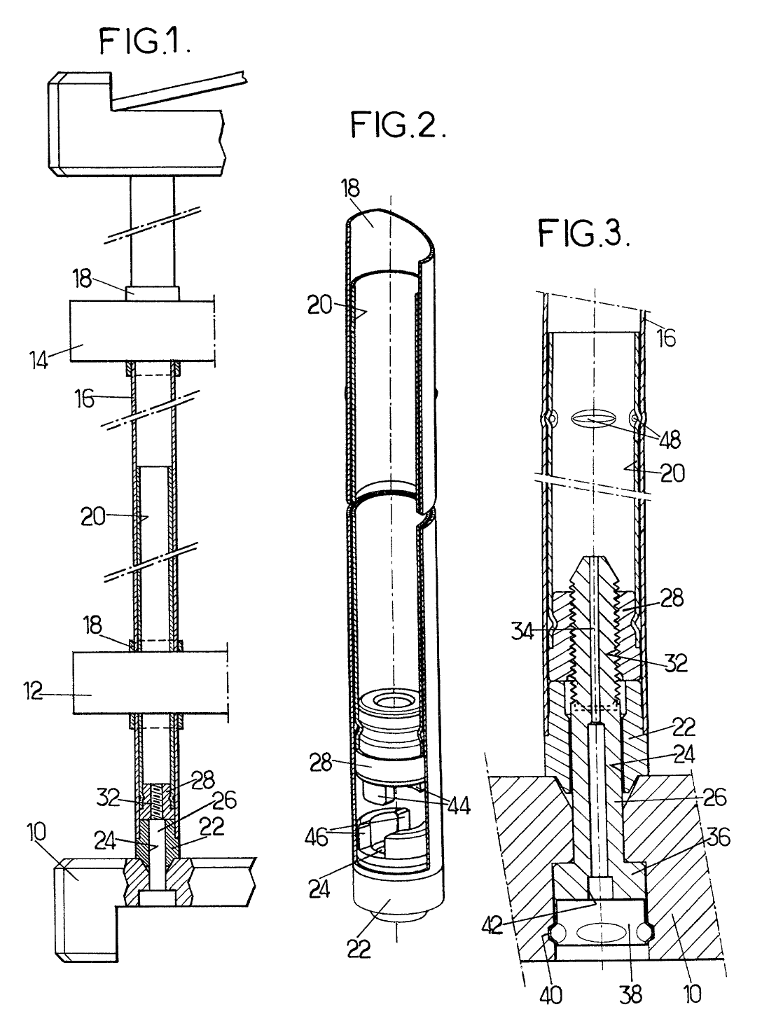

FIG. 2 is a perspective view, partially in section, showing the relative disposition of the bottom portions of a guide tube and of a cartridge, the cartridge being shown at a location prior to relative engagement between the two plugs;

FIG. 3 is a section view of the bottom portion of the guide tube in FIG. 1;

FIG. 4 is a view showing the plugs prior to assembly, in elevation in a direction perpendicular to the plane of FIG. 3;

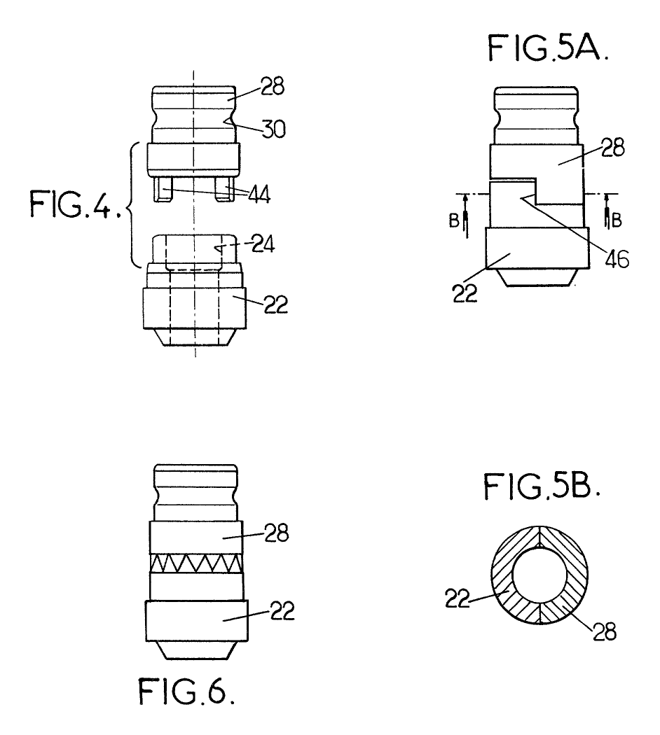

FIGS. 5A and 5B show a pair of plugs in a variant embodiment, respectively in elevation and in section on line B-B of FIG. 5A; and

FIG. 6 is similar to FIG. 5A and shows a variant.

FIG. 1 shows the relative disposition of the bottom nozzle 10, of the two bottom grids 12 and 14, and of a guide tube 16 in a nuclear fuel assembly of a kind that is commonly used at present. The grids have sleeves 18 spot-welded to the guide tubes 16. The bottom portion of each guide tube 16 contains a cartridge 20 to reduce the right section in which a control cluster rod engages as the rod comes near to the bottom of its stroke. The cartridges may also serve to reinforce the bottom portions of the guide tubes. For greater clarity in FIG. 1, the means for fixing the guide tube 16 and the cartridge 20 to the bottom nozzle 10 are not shown.

In the embodiment of the invention shown in FIGS. 2 to 4, the guide tube 16 is closed by a bottom plug 22 which is welded to the tube and which has a tapering projection for engaging in a recess of complementary shape in the bottom nozzle 10 so as to center the guide tube. A smooth axial hole 24 (shown in FIG. 3) is formed through the plug 22 of the guide tube to pass the shank of a screw 26 for fixing it to the bottom nozzle 10.

The cartridge 20 is provided with a bottom end plug 28 that is permanently fixed to the cartridge 20, e.g. by rolling. For this purpose, the plug includes a circumferential groove 30 (FIG. 4) into which the thin wall of the cartridge is driven. An axial tapped hole 32 is provided in the plug 28 to receive the threaded end portion of the shank of the screw 26.

The screw 26 is pierced by a calibrated axial passage of a diameter that is selected as a function of the dashpot effect desired while a rod is dropping. The head 36 of the screw bears against a shoulder provided for this purpose in a recess in the bottom nozzle 10. It is extended by a thin skirt 38 designed to be deformed into indentations provided for this purpose to prevent the screw from rotating. A socket 42 may be provided in the head of the screw to receive a tool for tightening and loosening it.

Co-operating means are provided on the plugs 22 and 28 to prevent relative rotation between them. In the example shown in FIGS. 2 to 4, these means comprise two diametrically opposite and axially directed fingers, that can be thought of as constituting a tenon 44 interrupted by a smooth hole for passing the shank of the screw 26.

The complementary means provided on the guidetube plug 22 are constituted by two projections defining a mortise 26 (FIG. 2) interrupted by the smooth central hole 24 for passing the shank of the screw 26.

In the variant embodiment shown in FIGS. 5A and 5B, the plugs 22 and 28 bear against each other via a single diametral shoulder 46. In each plug, this shoulder defines an extension or projection that is half-moon shaped.

In FIG. 6, the co-operating means are constituted by two sets of teeth engaged one in the other. The teeth slope sufficiently steeply (in practice at more than 45°) to prevent torque exerted on the screw initially rotating the cartridge plug 28.

The components described above can be assembled as follows.

Initially a skeleton subassembly is built up as are blocks each constituted by a cartridge and a bottom end plug.

Each block may be made, for example, by engaging the cartridge 20 on the cartridge plug 28 until it comes into abutment against the shoulder provided for that purpose, and then crimping the cartridge into a circumferential groove 30 of the plug.

The skeleton subassembly may be built up in conventional manner by spot welding the grids to the guide tubes and possibly by putting a top nozzle into place.

Thereafter, each cartridge is inserted until it bears against the corresponding guidetube plug 22. By rotating the cartridge, it is brought into an appropriate orientation, e.g. to enable the tenon of the cartridge plug 28 to engage in the corresponding mortise (FIGS. 2 to 4). At this stage, the cartridge can be temporarily secured to the guide tube to keep the jaw clutch in engagement, e.g. by locally expanding the thin wall of the cartridge into the thin wall of the guide tube at points 48 (FIG. 3). Such fixing also makes it possible to perform subsequent repair operations on site, should that be necessary.

Thereafter, the bottom nozzle 10 is put into place on the guide tubes and the screws 36 are screwed into the cartridge plugs 28 generally by means of a tool that includes means for adjusting the tightening torque.

Numerous other variants of the invention are possible, and in particular the cartridge may be of varying shape with an end that is chamfered or as described in patent application FR 96 08092.

1/ A nuclear fuel assembly skeleton having a top nozzle and a bottom nozzle (10) interconnected by guide tubes (16) designed to receive control cluster rods and each containing, at its bottom end, a tubular cartridge (20), each of said tubes being provided with a bottom plug (22) that bears against the bottom nozzle (10) and that is pierced by a hole for passing a fixing screw (26),
characterized in that the cartridge (20) includes a bottom plug (28) bearing against the guidetube plug (22) and in that the facing faces of the two plugs (22, 28) present axial projections that co-operate with one another to lock the two plugs against relative rotation once said screw (26) has been screwed into a tapped hole (32) in the cartridge plug (28).

2/ A skeleton according to claim 1, characterized in that said projections constitute a jaw clutch.

3/ A skeleton according to claim 1, characterized in that said axial projections comprise a tenon (44) on one of the plugs (28) and a diametral mortise (26) in the other plug.

4/ A skeleton according to claim 1, characterized in that said projections constitute complementary sets of teeth.

5/ A skeleton according to claim 1, characterized in that each of said projections is defined by a diametral shoulder.

6/ A skeleton according to claim 1, characterized in that the fixing screw (26) includes a head (36) bearing against the bottom of a recess in the bottom nozzle and extended by a skirt (38) that is deformable into indentations (40) in the recess.

7/ A skeleton according to any preceding claim, characterized in that the guide tubes carry grids (12, 14), and in that the cartridge extends to higher than the two bottom grids.

8/ A method of assembling a nuclear fuel assembly skeleton, in which:
blocks are built up, each constituted by a cartridge (20) and an end plug (28) having a tapped hole, the cartridge and the plug being fixed to each other;
a skeleton subassembly is built up comprising guide tubes, each provided with a bottom plug pierced by a smooth axial hole, the tubes being assembled together by grids welded to the tubes;
the blocks are inserted as snug fits in respective guide tubes and they are oriented so as to cause the facing projections of the cartridge and guidetube plugs to engage mutually; and
a bottom nozzle of the assembly is fixed to the guide tubes by screws each having a head bearing against the nozzle and a shank passing through the bottom plug of the guide tube and screwed into the tapped hole of the cartridge plug.

9/ A method according to claim 8, characterized in that the cartridge and the cartridge plug are fixed to each other by crimping in a circumferential groove of the plug.
